(19) United States
(12) Patent Application Publication
(10) Pub. No.: US 2020/0360113 A1
(43) Pub. Date: Nov. 19, 2020

(54) Tremor Control Device

(71) Applicant: Kimberly K. Zamorano, Oklahoma City, OK (US)

(72) Inventor: Kimberly K. Zamorano, Oklahoma City, OK (US)

(21) Appl. No.: 16/986,031

(22) Filed: Aug. 5, 2020

Related U.S. Application Data
(63) Continuation-in-part of application No. 15/674,997, filed on Aug. 11, 2017.

(51) Int. Cl. A61C 7/08; A61C 7/36

(52) U.S. Cl. CPC A61C 7/08; A61C 2204/00; A61C 2201/00; A61C 7/36

(57) ABSTRACT

A tremor control device comprising a structure positioned within a patient's maxilla that removably engages a patient's maxilla and rigidly maintains the structure in a desired position, a pressure applicator platform rigidly affixed to the structure and positioned under a single trigger point with a surface that removably engages a pressure applicator, and the pressure applicator engages and applies a determined amount of pressure to the single trigger point on a posterior medial gumline of a lingual aspect of the patient's maxilla, where the determined amount of pressure selected is found to reduce the patient's tremors, whereby the structure is placed and secured within the patient's maxilla and the pressure applicator is affixed to the pressure applicator platform whereupon placement of the structure within the maxilla, the pressure applicator engages the single trigger point and applies the determined pressure thereby reducing body tremors.

### CROSS-REFERENCE TO RELATED APPLICATIONS

Applicants claim benefit pursuant to 35 U.S.C. § 120 and hereby incorporate by reference a non-provisional patent application for “Tremor Control Mouth Piece”, application Ser. No. 15/674,997, filed Aug. 11, 2017.

### FIELD OF THE INVENTION

The invention generally relates to an apparatus placed and secured in the mouth to assist with controlling and reducing the signs of neurogenic tremors and neurological spastic hemiparesis. In particular, the invention relates to an apparatus for controlling and reducing tremors by placing pressure on a pre-determined trigger point in the lingual aspect of the maxilla, where the removable apparatus is positioned and secured inside the mouth of a person with tremors and a pressure applicator engages the pre-determined trigger points to provide the minimal amount of pressure required to facilitate decreasing the severity and frequency of tremors.

### BACKGROUND

The mental, social, and physical stigma of people with self-uncontrollable Autonomic Nervous System Imbalances of autonomic flexibility in the Autonomic Dysreflexia or Autonomic Hyperreflexia systems manifesting as trembling and quivering, either internally or externally, is at times insurmountable. Diagnosis and current treatments which relate to neurological disorders without the use of medications or surgery, which could manifest as unwarranted side effects, compounds the stress of living with the imbalance even further. Addressing the disruption of daily living skills such as: eating, drinking, dressing, grooming, and public appearances is critical to a better quality of life. Giving a neurologically impaired person the power to maintain emotional, mental, physical health and increasing the quality of human life, without use of chemicals and their unwarranted side effect, risks of a surgical procedures and possible complications, and other solutions that have their own associated problems is highly desirable.

Physicians have attempted to find relief for persons afflicted with tremors with medications, hypnosis or shock therapy, and these solutions work to varying degrees. Medications may present undesirable side effects that make the solution worse than the tremor itself. Through hypnosis, most psychiatrists focus on the trance state brought on by intentional relaxation and focusing exercises. Intentional relaxation may be unobtainable for Restless Leg Syndrome patients as many may tremble while resting or asleep. Some people have difficulty focusing on a task at hand and retaining a focused relaxation exercises using the same muscle group at the same time. Electroshock therapy (ECT) or “convulsive therapy” has been used since 1938 to treat certain forms of mental illness by causing convulsive seizures within the brain. Administered four to twelve times in a hospital setting, partial memory loss sometimes occurs with treatment, and outcome is not certain until recovery. Frequently facilities and insurance companies have deemed ECT as a barbaric form of treatment and refuse to engage in this form of therapy. Sweden frequently treats Parkinson's disease with a surgical procedure in which the patient's brain is re-sectioned into distinct hemispheres; again, outcome is not certain until recovery. Deep Brain Stimulation (DBS) is a surgical procedure which attaches a stimulator deep in the mid-brain. The high risk, invasive surgery ensures lengthy rehabilitation without a guarantee of the successful resolution of the neurological impairments or the patient's ability to socially re-integrate. DBS is not genuinely used for patients affected by relatively mild tremors. A Vegus Nerve Stimulator (VNS) device implanted subdural left subclavicular, sends a burst shock, on a timed interval, which is received by the brain to reduce or stop the tremor. However, after two years, the solution has found to relieve only 49% of the patients, and some do not respond to VNS therapy at all. Each of the aforementioned solutions has their own possible side effects, complications, or unforeseen outcomes.

Craniosacral Therapy (CST) is a noninvasive method that releases tensions in the body to relive pain and dysfunction and to increase overall body health and performance by normalizing the flow of cerebrospinal fluid in the central nervous system. CST relieves the tension in the head neck and back using light pressure and touch to relieve the stress and pain caused by compression. Through the normalizing of the flow of cerebrospinal fluid, the body's ability to self-correct is restored and in some cases enhanced. CST may be able to alleviate a multitude of dysfunctions including, but not limited to, chronic pain, physical injuries, stroke, and neurological impairments.¹ ^{1 1} Upledger Institute International, “What is CranioSacral Therapy?”, Upledger Institute International, https://www.upledger.com/therapies/faq.php (accessed Jul. 29, 2020).

Normalizing the flow of cerebrospinal fluid requires a CST trained professional to perform an assessment on a patient to detect potential restrictions in the craniosacral system. Once the restriction(s) in the craniosacral system have been detected after the evaluation, the practitioner uses soft touch techniques to remove the restrictions influencing the craniosacral system.² As part of CST, a 10-step protocol was developed to identify and evaluate any restrictions in the craniosacral system and provide the appropriate treatment. While CST does provide some relief to various dysfunctions, it was not able to provide relief of the self-uncontrollable Autonomic Nervous System Imbalances of autonomic flexibility in the Autonomic Dysreflexia or Autonomic Hyperreflexia systems manifesting as trembling and quivering.

### SUMMARY OF THE INVENTION

The present invention overcomes the shortcomings by expanding the ten step protocol to determine the trigger point for aforementioned trembling and quivering and providing a tremor control device when inserted into a patient's mouth, which applies a predetermined pressure to a single trigger point to reduce the neurogenic tremors. The tremor control device allows a patient that is a victim of neurogenic tremors, the ability to control their moveable body parts including, but not limited to, limbs and head without medications, diet restrictions, orthopedic braces, or social embarrassment. Assisting the patient's ease of comfort for daily living skills such as: eating, personal hygiene, social interaction and recreation activities is obtainable. The apparatus may consist of a device having a structure to engage the upper part of the mouth, a pressure applicator and connector to removably affix the device to the upper part of the mouth.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. ² Upledger Institute International, “How does CranioSacral Therapy Work?,” Upledger Institute International, http://www.upledger.com/therapies/faq.php (accessed Jul. 29, 2020).

### DESCRIPTION OF THE DRAWINGS

FIG. 1 is a perspective view of the upper portion of the mouth and a retainer according to the present invention to engage the upper portion.

FIG. 2 is an underside view of the upper portion of the mouth and retainer according to the present invention to engage the upper portion.

FIG. 3 is a perspective view of a denture with a pad.

FIG. 4 is a view of the upper portion of the mouth with tremor control device engaged.

FIG. 5 is an illustration of synaptic process.

### DETAILED DESCRIPTION OF THE INVENTION

The Craniosacral system (CS) consists of the membranes and bones which surround and protect the brain and spinal cord which encourages and facilitates circulation of spinal fluid, from the jaw and cranial vault (head) down to the sacrum and coccyx (tailbone). The Craniosacral system has a Craniosacral Rhythm (CSR) which contains general vitality used to evaluate paravertebral musculature to assess innervation of tissues. Innervation is caused by a change, either an increase or decrease, of cerebrospinal fluid produced and reabsorbed at a regular rate typically, six to twelve cycles per minute within and around the central nervous system (brain and spinal cord) and may be palpated by practitioner's hands. Craniosacral Therapy (CST) is a gentle, light-touch method of evaluating and enhancing the CS system, the environment in which the brain and spinal cord function. An imbalance or dysfunction in the CS system can cause sensory, motor, or neurological disabilities. These problems may include chronic pain, eye difficulties, scoliosis, motor-coordination impairments and learning disabilities, as well as other physical and psychological problems. A CST practitioner uses a gentle, alternative, light touch manual therapy, detecting and correcting imbalances in the CS system by encouraging the release of tension within the Dura and Pia mater of the spinal column so every other system in the body can relax, self-correct, and free itself of pain and discomfort. Current understanding is certain physical problems may be caused by disturbances in the movement or lack of movement in the cranial structures and normal rhythmic flow of the craniosacral system. The 10-step protocol was developed by Physicians for CST practitioner's use in treating the craniosacral system for patients worldwide. The CST practitioner may use a technique of arcing to discover and locate active (energy-producing) problems such as an active energy lesion. As the practitioner moves closer to an energy cyst the tighter the arc. Once a problem has been resolved there will be no residual arcing. Arcing allows the practitioner to evaluate the effectiveness of the therapy.

Through experimentation, several additional steps were identified to evaluate and effectively treat a patient with the aforementioned trembling and quivering. These additional steps hereinafter will be referred to as the “Zamorano Method.” Typically, the Zamorano Method follows the completion of the 10-step protocol when treating the trembling and quivering. The Zamorano Method may consist of six additional steps and these steps may be completed in any order as the one skilled in the art prefers. These steps include the following: 1) Transverse Compression/Decompression, 2) Cervical Muscle Torsion Release, 3) Frontal Lobe Fascial Release, 4) Trigeminal Nerve Sheath Release, 5) Maxilla/Parietal Alternate compression Technique, and 6) Anterior Incisor Papilla Lift. The Zamorano Method must be performed by a trained individual otherwise the patient may be placed at risk for injury.

Step 1 of the Zamorano Method is the performance of the Transverse Compression/Decompression. While the patient is supine (lying on their back), one skilled in the art (“practitioner”) is seated at the head of the table, where they rest their arms and hands upon the table next to the patient and extending fingers above the supine patient's head. The practitioner lays their hands gently over the sides of the patient's head so that the ears and temporal regions are covered by the base of the practitioner's palms. The practitioner slowly and gently, usually 2 seconds to 2 minutes, performs a lateral transverse compression/decompression engaging CSR intervals of flexion and extension's during the neutral gap while preferably applying 3 to 5 gf/cm² (0 to 10 gf/cm² depending on patient's age, weight, medical condition, need, intent) encouraging flexion of cranial vault and facilitating Dural tube release. The Neutral Gap is the slight pause before the flexion into extension and again before the extension into the flexion of a given range of motion. Movement should be within the timed intervals of patient's CSR neutral gap, in approximately 1/16-⅛ inch increments to the patient's end range of motion boundaries, following patient's established CSR. If practitioner determines patient's CSR is diminished or absent, practitioner may gently, and slowly return to last position of CSR notation. When the range of motion is completed, practitioner applies compression to still point and waits for patient lesion, torsion, or shear to clear and soften. Shear involves no rotational component. A lateral displacement of the surface, uneven comparison of the distance and ease with which a surface travels to the left and to the right. The dysfunction is named for the direction of greatest excursion and ease. The time to perform this step varies depending on the patient. Typically, a practitioner my take around 10 minutes to perform this step depending on the patient's response and the detections of lesions, energy cysts or restrictions. An energy cyst is residual localized energy which has been introduced into a patient's body by external or internal trauma. A lesion is a somatic dysfunction which is further defined as impaired or altered functions of related components of the somatic (body framework) system. It can include the musculoskeletal, nervous, or lymphatic systems.

Step 2 of the Zamorano Method is the performance of the Cervical Muscle Torsion Release. While the patient is supine, the practitioner is seated at the head of the table, where they rest their arms and hands upon the table next to the patient's head. Practitioner lays their hands gently over the side of the patient's head so that the ear and temporal region are covered by the base of the palm, fingers extended over the anterior aspect of the cheek bone, cheeks, and jaw. Practitioner gently and slowly places their other hand on patient's sternum. Practitioner applies a slow, and gentle (2 seconds to 2 minutes) inferior traction to the skin surface of the sternum toward feet, while practitioner also applies a midline slow and gentle traction to the anterior aspect of the cranial vault of the same side simultaneously. Practitioner unwinds or stretches the bilateral neck muscles and fascial glide using alternate anchoring platform of sternum, clavicle, acromion process with temporal, occiput, parietal bones, respectively. Fascial glide refers to the mobility of the fascia, specifically the mechanics of movement between fascial layers. Practitioner allows adequate time for fascial glide to present and resolve. Practitioner follows the inherent motion which they may perceive which may be to either the lateral (hand on side of head) or anterior (hand on breastbone, which is still gliding toward feet) but practitioner does not attempt to impede movement. Practitioner follows the unwind or stretch movement, with the upper thoracic and cervical muscles to their end of motion and holds until CSR is detected. Practitioner allows time for patient to react, respond, or process to tissue release and softening before proceeding. Once the Cervical Muscle Torsion Release is completed on one side of the patient, the practitioner applies Cervical Muscle Torsion Release to the opposite side of patient. After completion on both sides of patient, practitioner may recheck CSR using bilateral zygomatic arch and recalibrate if necessary. Recalibration requires the practitioner to assess the Craniosacral rhythm and if the practitioner discovers an imbalance not noted prior to the Zamorano Method, the practitioner may perform one of the 10-step protocol methods before proceeding to the next step. Otherwise, Practitioner may continue with the next step. The time to perform Step 2 varies depending on the patient. Typically, a practitioner my take around 10 to 20 minutes to perform this step depending on the patient's response and the detections of lesions, energy cysts or restrictions.

Step 3 of the Zamorano Method is the performance of the Frontal Lobe MyoFascial Release. While the patient is supine, the practitioner is seated at the head of table. Practitioner places finger pads from both hands evenly across patient's forehead above the brow line. Practitioner gently engages patient using skin contact only, avoiding any posterior pressure, making small 1/16-⅛ inch increment movements in a plus (+) pattern. While practitioner monitors patient's respirations including but not limited to depth, amount, and quality, practitioner performs a fascial glide release using frontal lobe and focuses intent on release of the superior and anterior aspect of ethmoid. Practitioner applies skin contact using 0 to 5 gf/cm² finger pad pressure to resolve possible frontal and parietal shear. Practitioner checks for end of motion using Myofascial Release (MFR) glide 1/16 to ⅛ inch movements within the CSR neutral gap of flexion/extension cycle. MFR is a term used for fascial restriction relaxation including, but not limited to, fascial glide, fascial slide, friction massage, ice massage, traditional massage, sports massage, acupressure, acupuncture, manual manipulation, stretch, yoga, and Rolfing massage. Practitioner monitors patient's respiration and if the respirations SQAR changes, practitioner holds position until ethmoid or lachrymal restriction is released and the respirations return to patient's “normal.” SQAR is an acronym that refers to the manual palpation findings of the practitioner at the basic 8 “listening stations” taught in CST classes. The S in SQAR refers to the symmetry of the craniosacral rhythm, where the practitioner compares the left side of the patient's listening station to the right side of the listening station to observe any movement with the CSR into flexion and extension, and/or back and forth from the midline or center of the patient from the spine. The Q in SQAR refers to the quality of the CSR such as is the rhythm present or not, is the rhythm easy to detect, if so, is the rhythm consistent. The A in SQAR refers to the amplitude of the CSR meaning how strong is the rhythm, is it thready or bounding. The R in SQAR refers to the rate of the CSR in terms of how many times a minute the increase and decrease of cerebrospinal fluid is produced and reabsorbed within and around the central nervous system (brain and spinal cord). SQAR should be evaluated at each basic listening station of the patient before and after treatment and during a session to check progress of the treatment by manual palpation of the practitioner by comparing both hands simultaneously at the same point. Practitioner may continue once the patient's respirations return to “their normal” or tissue softens under practitioner's finger pads. Practitioner may allow patient's body time to resolve and relax bones in the upper part of the bridge of the nose. Practitioner gently and slowly removes finger pads from frontal bone. Practitioner moves the fingers toward the top of the head approximately ⅛ inch from previous treatment site and gently reapplies finger pads and perform Step 3 to the new treatment site. A practitioner typically may treat four to six sites on the forehead.

Step 4 of the Zamorano Method is the performance of the Trigeminal Nerve Sheath Release. While the patient is supine, the practitioner is seated at the head of table. Practitioner gently and slowly inserts the 2^{nd} and 3^{rd} digits of the same gloved hand, preferably the practitioner's dominate hand, into patient's mouth while maintaining a symmetrical and even anterior movement. Practitioner may perform a myofascial release on the sheath of the medial head of the trigeminal sheath. Practitioner starts the myofascial release under the nose and continues toward the jaw, just in front of the ear, then rounding down the jaw line to the middle of the lower teeth. As the release is performed, the patient may experience slight discomfort while the tissue is releasing. Practitioner should take care not to impede the release and should follow the tissue releasing and allow the blend and meld to be completed. Practitioner may recheck the inferior temporal mandibular joint release for SQAR.

Step 5 of the Zamorano Method is the performance of the Maxilla/Parietal Alternate Compression Technique. This step may be performed on a patient in several different positions including, but not limited to, supine to standing. Practitioner may insert the gloved index finger into the patient's mouth and examine the lingual aspect of hard palate for positive presence of freed soft tissue while the other extended hand rests lightly on the top of the patient's head. Practitioner may gently apply pressure to the hard palate and frontal lobe alternately using 0 to 5 gf/cm² of compression. The frontal lobe will move with a motion that may be described as a “bounce.” Practitioner may apply fingertip pressure, in a clockwise then counterclockwise direction, to the ridges of the hard palate parallel to the upper teeth. After performing this step, practitioner may perform a supplemental check of the sphenoid and maxilla relationship using a hard palate evaluation and balancing technique. Additionally, practitioner may perform a supplemental check maxilla anterior glide for SQUAR.

Step 6 of the Zamorano Method is the performance of the Anterior Incisive Papilla Lift. While the patient is supine, the practitioner is seated at the head of table. Practitioner may place gloved hand, using 1st and 2nd digit pinch, facilitated by 0 to 5 gf/cm² anterior lift noting ARC on patient's papilla. Practitioner may observe potential tissue softening in the area between the patient's incisors in the back. Practitioner lifts left posterior incisor at left of midline papilla toward mouth opening with 0 to 5 gf/cm² of pressure applied to the papilla for 5 to 30 seconds. Practitioner to observe patient's physical response as the pinch is applied. Once the patient has recovered from the first pinching procedure, practitioner moves gloved finger thumb pinch to the left front tooth, near the gumline, with the intent on the back, area near midline of palate. Practitioner lifts posterior midline papilla toward mouth opening with 0 to 5 gf/cm² of pressure applied to the papilla for 5 to 30 seconds. Observe patient's response and note any softening of tissue or change in physical activity. Once the patient has recovered from the second pinching procedure, practitioner moves gloved finger thumb pinch to the right front tooth, near gumline, intent is on the back area near midline of palate. Practitioner lifts right posterior incisor at right of midline papilla toward mouth opening with 0 to 5 gf/cm² of pressure applied to the papilla for 5 to 30 seconds. Observe patient's response and note any softening of tissue or change in physical activity. Practitioner typically allows for 30 seconds to 2 minutes between each lift application.

Once practitioner completes the 10-step protocol and then the Zamorano Method, the last step being the “lift” of the papilla on the three different pressure points, the practitioner may visually observe through this lift procedure a reduction in external tremors while applying pressure to one of the potential trigger points. The point that provides the desired reduction of external tremors is the single trigger point that the apparatus will apply pressure.

Once the single trigger point is identified a tremor control device described herein may be crafted for the patient. Once the tremor control device is received, a final fitting is performed and the pressure applicator 120 is adjusted to provide the desired pressure to the trigger point. Currently, the present invention is designed to address tremors, however, the present invention may be able to affect other medical conditions in the same way by applying pressure to other trigger points associated with particular medical conditions.

Observations have shown, a small amount of pressure (1 to 10 gf/cm²) applied by the raised area on the lingual aspect of the maxilla near the central incisor, on upper gingiva will occlude the CA(++) channel between the synaptic cleft dendrite and axon terminal causing the neurotransmitter-receptor an invalid connection transfer energy space near the maxillary division of the Trigeminal Nerve (V). Thus, an interception of spastic muscle signals to the Pons in the brain stem for the autonomic nervous system to react to manifesting noticeably fewer or diminished limb tremors. Several of the observations are discussed below.

On Nov. 2, 2015, an elderly patient had external spastic tremors related to a diagnosis of Parkinson's disease. The patient received CST and also received the additional oral manipulations to identify the trigger point for this particular patient. After locating the trigger point the therapist asked the patient to place their tongue on the trigger point and apply pressure. After applying pressure, the external spastic tremors related to Parkinson's disease visibly stopped or diminished as a result of the maintaining constant pressure on that point.

On Mar. 7, 2015, an elderly patient having familial bilateral upper extremity neurogenic tremors had displayed tremors for over 30 years. The tremors were so great the patient could not get a spoonful of peas to their mouth. The patient received CST and the additional oral manipulations to identify the trigger point for this patient. The therapist applied pressure digitally to the trigger point and the tremors were diminished to a level that was acceptable to the patient.

In March 2016, a young patient was experiencing extremity neurogenic tremors caused by fever of unknown origin when the patient was living abroad. The patient received CST and the additional oral manipulations to identify the trigger point for this particular patient. After locating the trigger point the therapist asked the patient to place their tongue on the trigger point and apply pressure. After applying pressure, the external spastic hemiparesis tremors were no longer present when the pressure remained. For the first time in their life the patient was able to extend their right arm to retrieve a full bottle of water without tremors shaking and spilling the water on their self or the floor.

In June 2016, a patient experiencing excruciatingly painful bilateral foot neuropathy and restless leg syndrome had tried pharmaceuticals, acupuncture, physical therapy and was seen at the Mayo Clinic but nothing seemed to help. The patient received CST and the additional oral manipulations to identify the trigger point for this particular patient. The patient could press their tongue lightly against the identified pressure point and diminish the pain in their feet, and the legs were noticeably able to relax, without spastic movement.

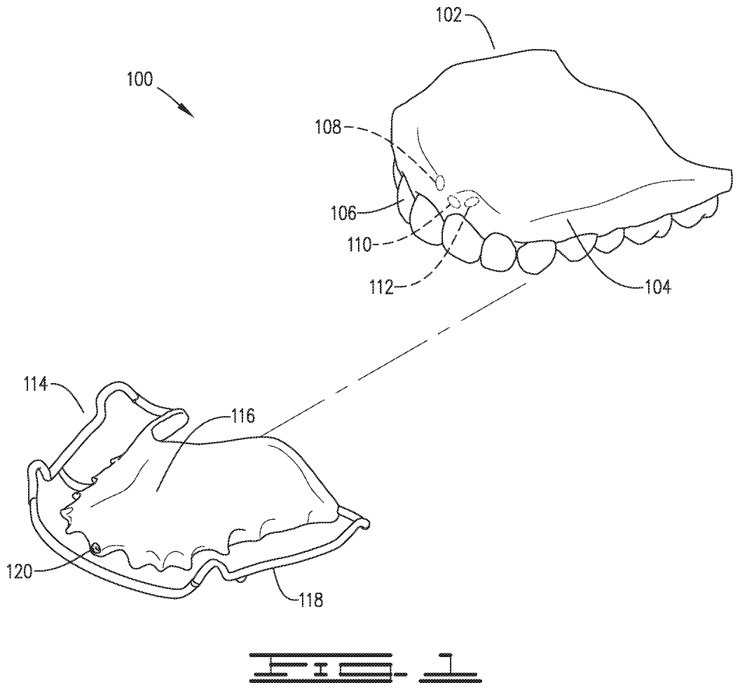

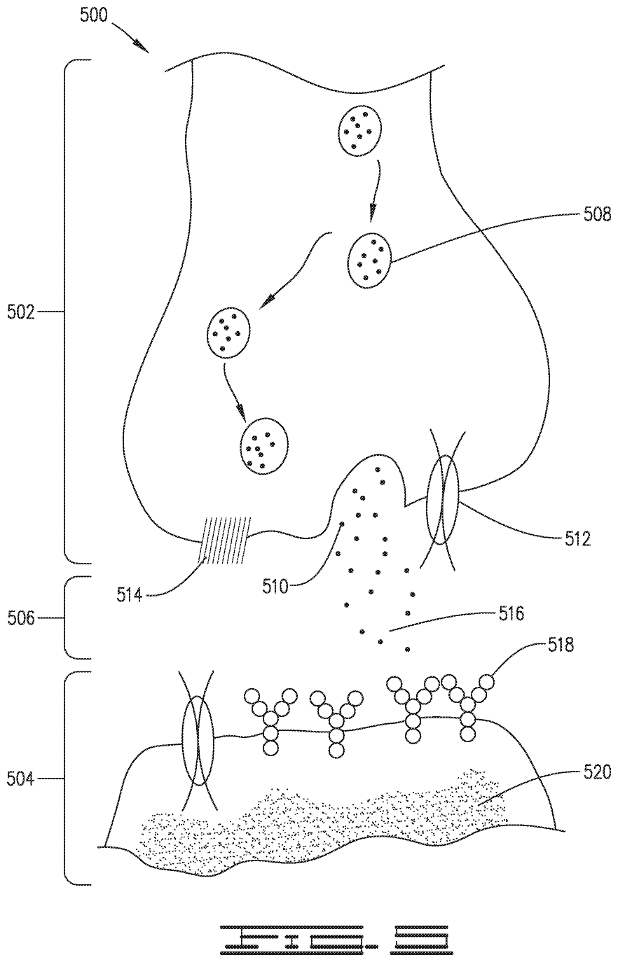

FIG. 1 is an exploded view of the upper mouth from the top with a retainer detached 100. This view of the upper mouth 102 shows the gingivae 104; teeth, specifically the incisors teeth 106 with a left trigger point 112, a middle trigger 110 and a right trigger point 108. Hereinafter, the left trigger point 112, the middle trigger 110 and the right trigger point 112 will each, for simplification purposes, be referred to as a “trigger point” for the reasons discussed below. Typically, one of the trigger points 112, 110, 112 may be engaged to affect the neurogenic tremors in a specific patient. Current anecdotal evidence does not suggest any added benefit by engaging multiple trigger points 112, 110, 112 simultaneously. Moreover, engaging more than one trigger point at a time may result in a deleterious effect. Every patient is different and the trigger points 112, 110, 112 and pressure required to induce a therapeutic effect for an individual patient may be determined through a Zamorano method after the completion of the 10-step craniosacral treatment protocol. Once this protocol has been completed, the specific trigger point 112, 110, 112 that will reduce, minimize, or possibly eliminate the neurogenic tremors may have been identified along with the appropriate pressure needed to engage the trigger point 112, 110, 112. With the appropriate trigger point 112, 110, 112 and pressure required identified for a patient, one skilled in the art may create a device for use inside the maxilla for the specific purpose of tremor control (see FIG. 4) or may modify other dental devices including, but not limited to, dentures, mouth guard, retainers, implants, splint, night guard, braces, and bridges previously fitted for by the patient to apply pressure the appropriate trigger point 112, 110, 112. The creation of the device may use the common methods used to create the aforementioned dental devices such as molding but may also include, but is not limited to, the use of three dimensional printing to create a new device or modify an existing device. Additionally, the device may be man-made, or computer constructed from materials including but not limited to resin, ceramic, metal, poly (vinyl acetate-ethylene) copolymer thermoplastic; polyurethane; laminated thermoplastic; thermo-polymer, acrylic, polypropylene or polyvinylchloride material, co-polymer, and polymer.

An embodiment of the invention is a retainer 114 that may comprise a base plate 116, a metal wire 118, and a pressure applicator 120. One skilled in the art would be aware that the base plates for these types of retainers may be acrylic or created using vacuum formed polypropylene or polyvinylchloride materials. The pressure applicator 120 may be designed to apply the appropriate pressure to the selected trigger point 112, 110, 112 determined to have a desired effect on the neurogenic tremors for that patient. For illustration purposes, the right trigger point 112 will be used but the design and application would be the same for the left trigger point 112 and the middle trigger point 110. This pressure applicator 120 may be designed to apply 1 to 15 gf/cm² of pressure to the appropriate trigger point 112 identified during the earlier multistep craniosacral protocol and the Zamorano method. A retainer 114 may preferably be designed with the pressure applicator 120 in a corresponding position to the determined trigger point 112 to apply an appropriate amount of pressure to the trigger point 112 thereby reducing, minimizing, or possibly eliminating the neurogenic tremors. The retainer 114 may be adjusted to apply this desired pressure by adding different thicknesses of the pressure applicator 120 to achieve the desired pressure. The pressure applicator 120 material may include, but is not limited to polymers, copolymers, metal, rubber, adhesives, and cloth. The pressure applicator 120 material may be layered or varied in thickness to change the level of pressure applied to the trigger point 112. By varying the thickness and providing the ability to layer, one skilled in the art can fine tune the patients pressure to the minimal required to have a therapeutic effect. Any more pressure than is required to have the therapeutic effect, may desensitize the trigger point 112.

Typically, this retainer 114 may be removable where a patient may wear the retainer 114 to provide the effect of reducing, minimizing, or eliminating the neurogenic tremors when they are out in public so to minimize their embarrassment. The removable retainers 114 are the preferred embodiment because a fixed retainer applying a consistent pressure to the determined pressure point may over time likely desensitize that trigger point 112, 110, 112 and allow the neurogenic tremors to increase and or return to the patient.

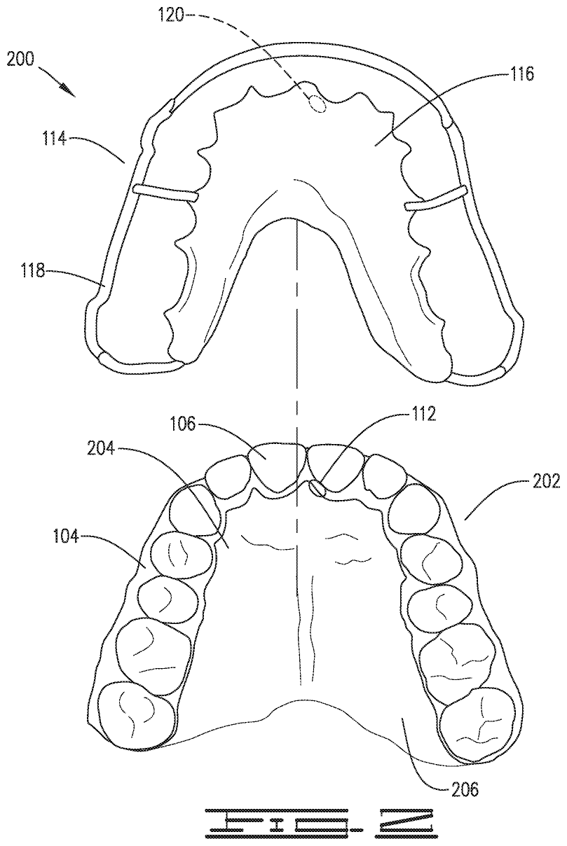

FIG. 2 is an underside view of the upper mouth with a retainer detached 200. This view shows the trigger point, 112, next to the incisor, 106 on the upper roof of the mouth 202. The other trigger points, as described earlier, the left trigger point, 112, the middle trigger point, 110, are also located near the central incisors, 106. Additionally, this view illustrates the relational location to the hard palate, 204 and the soft palate, 206, which provides a reference for the trigger points 112, 110, 108, that is, in this illustration, medial to the right central incisor, 106. When the retainer, 114, is placed inside the mouth and over the upper teeth the pressure applicator 120, applies direct pressure to the example trigger point, 112, to provide the pressure determined earlier with the craniosacral protocol.

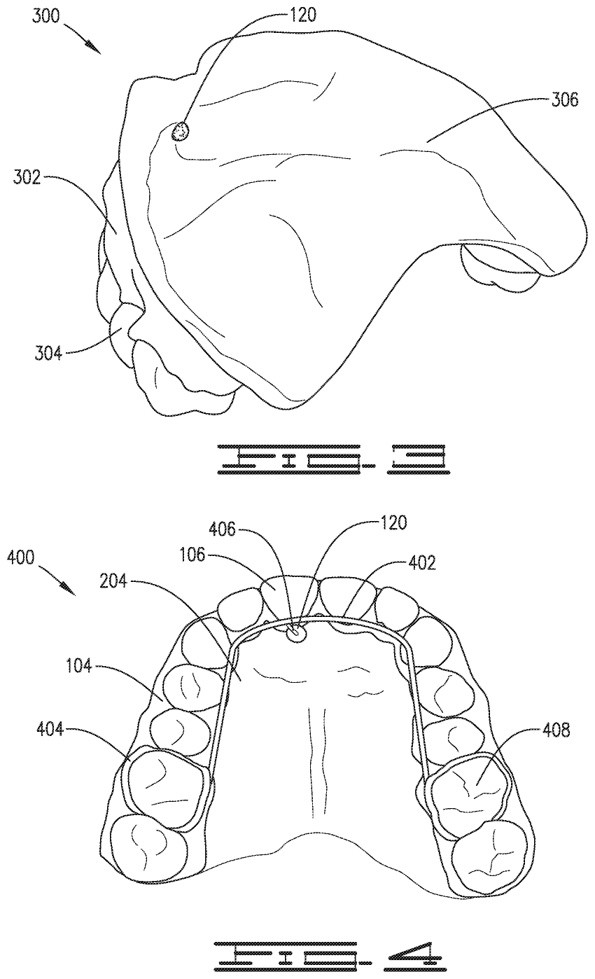

FIG. 3 illustrates a perspective view of another embodiment of the invention using a complete upper denture 300 with the pressure applicator 120. In this embodiment, the complete upper denture 300 comprises the simulated gingivae 302 and simulated teeth 304 and has a denture upper surface 306. One skilled in the art in creating an upper denture 300, a denturist, may form the upper denture 300 with the pressure applicator 120 as part of the upper denture 300 itself. Additionally, the upper denture 300 may be created with thicker pressure applicator 120 that would allow it to be adjusted to acquire the desired pressure for the patient once the dentures are received. The excess material may be removed by one skilled in the art to create the desired amount of pressure to provide the therapeutic properties to reduce, minimize or eliminate the neurogenic tremors. Additionally, a recess in pressure applicator 120 area or the patient's normal contour area will allow one skilled in the art to apply material to the denture 300 to build up the pressure applicator 120 to achieve the desired therapeutic results. The recess may provide for better adhesion of the pressure applicator 120.

FIG. 4 is a view of the upper portion of the mouth with a tremor control device 400 affixed to the upper teeth. The tremor control device 400 may comprise an upper fitted structure 402, a fastener in the form of a tooth anchor 404, and a pressure applicator platform 406 and a pressure applicator 120. The upper fitted structure 402 fits securely inside the mouth and is anchored to molars 408 on opposing sides of the mouth to minimize or prevent movement of the pressure applicator 120. The tremor control device 400 is positioned such that the pressure applicator platform 406 and the pressure applicator 120 apply pressure to the selected trigger point 112, 110, 108. The pressure applicator platform 406 may be mechanically adjusted for changes in the trigger point 112, 110, 108 and may be adjusted to also increase or decrease the pressure of the trigger point 112, 110, 108. As described above, the pressure applicator 120 may also be adjusted by adding or removing layers of material to the pressure applicator 120. For instance, pressure applicator platform 406 may be adjusted to apply less pressure than is required to provide therapeutic effect but then in combination, additional material may then be added to the pressure applicator to achieve the desired pressure and therapeutic effect. This combination may reduce the overall cost by reducing the amount of material need for the tremor control device 400.

Another embodiment of the tremor control device 400 uses a thermoplastic mouth guard wherein the thermoplastic is heated per the instructions, placed over the teeth and then fitted to such teeth. This type of mouth guard is commonly used in sports to protect athletes particularly in contact sports. Once the fitting of the mouth guard has occurred and it is secure then a pressure applicator 120 with the correct layering to provide the appropriate pressure to the trigger point 112, 110, 108 may be added to the thermoplastic mouth guard. This allows for a cheaper alternative as compared to modified dental device. For aesthetic purposes, the mouth guard may be trimmed such that it is invisible from the outside while keeping the pressure applicator 120 on the trigger point 112, 110, 108.

FIG. 5 shows an illustration of the chemical synaptic process 500. The trigger point 112, 110, 108 may be one of the synapses and the modified craniosacral treatment may identify the trigger points 112, 110, 108 for some neurogenic tremors. The axon terminal 502 of the neuron is separated from the synaptic cleft dendrite 504 of another cell by the synaptic cleft 506. The synaptic vesicles 508 containing the neurotransmitters 510 flows down through the axon terminal 502 where the synaptic vesicle 508 attaches to the presynaptic membrane. The voltage gated calcium CA(++) channel 514 triggers the release of the neurotransmitters 510 from the synaptic vesicles 508 into the synaptic cleft 506 where they are transported through the membrane via neurotransmitter transporter 512. Once attached the neurotransmitters 510 are released, they flow through the synaptic cleft 506 through the voltage (−) channel 516 to the receptors 518 and postsynaptic density 520 in the synaptic cleft dendrite 504 thus transporting the electrical information in the axon terminal 502 to the synaptic cleft dendrite 504 which is repeated to transfer signals to and from the brain and to and from other parts of the body. The pressure applicator acts to compress the synaptic cleft dendrite 504 and the axon terminal 502. Observations have shown, external tremors diminish or stop as long as 3 to 5 gf/cm² of pressure is applied to the upper mouth 102 near the alar cartilages to occlude or obstruct the channel 506. The pressure applied could range from 1 to 10 gf/cm² This occlusion of the channel 506 between the synaptic cleft dendrite 504 and axon terminal 502 near the distal edge of the medial head of the trigeminal nerve interrupts the electro-chemical synaptic process 500 nerve impulse/response loop received by the brain stem thereby reducing, minimizing, or eliminating the neurogenic tremors.

Having thus described the invention, I claim:

1. A device for controlling tremors in a patient comprising:
a. a structure positioned within an interior of a patient's maxilla, removably engages a patient's maxilla and rigidly maintains the structure in a desired position within the maxilla;
b. a pressure applicator platform rigidly affixed to the structure and positioned under a single trigger point with a cooperative surface to removably engage a pressure applicator; and
c. the pressure applicator to engage and apply a determined amount of pressure to the single trigger point on a posterior medial gumline of a lingual aspect of the patient's maxilla, where a determined amount of pressure as applied to the single trigger point selected is found to reduce the patient's tremors,
whereby the structure is placed and secured within the patient's maxilla, the pressure applicator of a desired size to produce the determined amount of pressure is affixed to the pressure applicator platform wherein upon placement of the structure within the maxilla, the pressure applicator engages the single trigger point and applies the determined pressure thereby reducing body tremors.

2. The device of claim 1, where the structure is selected from dentures, mouth guard, retainers, implants, splint, night guard, braces, and bridges.

3. The device of claim 2, where the structure is comprised of materials selected from resin, ceramic, metal, polyvinyl acetate-ethylene copolymer thermoplastic, polyurethane, seaweed, laminated thermoplastic, thermo-polymer, and acrylic, polypropylene or polyvinylchloride, co-polymer, and polymer.

4. A device for controlling tremors in a patient, the device comprising:
a. an upper fitted structure
b. at least one fastener to removably engage patient's maxilla and rigidly maintains the upper fitted structure in a desired position within the patient's maxilla;
c. a pressure applicator platform rigidly affixed to the upper fitted structure where the pressure applicator platform is positioned below a single trigger point with a cooperative surface to removably engage a pressure applicator; and
d. the pressure applicator, removably affixed to the pressure applicator platform, specifically sized to engage and apply a determined amount of pressure to a single trigger point on a posterior medial gumline on a lingual aspect of a patient's maxilla, where the determined amount of pressure as applied to the patients single trigger point selected is found to reduce the patient's tremors,
e. a single trigger point
whereby the upper fitted structure is positioned and secured inside the patient's maxilla and the pressure applicator applies the desired pressure to a single trigger point thereby reducing body tremors.

5. The device of claim 4, where the pressure applicator engaging the trigger point is selected from polymeric, rubber, and cloth.

6. The device of claim 4, where the pressure applicator that engages the single trigger point is varied in thickness to adjust the amount of pressure applied.

7. The device of claim 6, where the pressure applicator is layered to achieve the appropriate amount of pressure.

8. The device of claim 4, where the pressure applicator directly applies in a range of 1 to 10 grams/cm² of pressure to a single trigger point.
